(19) United States
(12) Patent Application Publication
(10) Pub. No.: US 2007/0244977 A1
(43) Pub. Date: Oct. 18, 2007

(54) DYNAMIC E-MAIL SYSTEM AND METHOD

(76) Inventor: Quixote Atkins, Lawrenceville, GA (US)

Correspondence Address: TROUTMAN SANDERS LLP, 600 PEACHTREE STREET , NE, ATLANTA, GA, 30308, US

(21) Appl. No.: 11/736,237

(22) Filed: Apr. 17, 2007

Related U.S. Application Data
(60) Provisional application No. 60/745,072, filed on Apr. 18, 2006.

(51) Int. Cl. G06F 15/16

(52) U.S. Cl. 709/206

(57) ABSTRACT

A computer program product and method of sending an electronic message. The program allows the content of the message to be changed dynamically after the message is sent. Changes can be made by the sender after the message has been transmitted or by predetermined user preferences. The program provides embedded links within the message that are associated to the content. The content associated with the hyperlink can be changed after the message is sent. The invention is preferably practiced as an e-mail system. The sender selects media stored on a sever such as music, picture, or video files. The user can also optionally enter text. The e-mail message contains embedded hyperlinks that automatically access the media or text, and display them within the recipients e-mail. The sender can later decide to change the content of the e-mail by changing the files that are associated with the hyperlink. The file associated with the hyperlink can also be changed automatically according to predetermined preferences.

### CROSS-REFERENCE TO RELATED APPLICATIONS

This application claims the benefit under 35 USC §119(e) to U.S. Provisional Patent Application Ser. No. 60/745,072 filed on 18 Apr. 2006.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING”

Not applicable.

### BACKGROUND OF THE INVENTION

1. Field of the Invention

The present invention relates generally to the field of e-mail, and more specifically to a dynamic e-mail system and method with the ability of a sender to send text, links, images, audio and/or video (media) via e-mail directly from a website or using his/her desired e-mail client, and it being immediately available (seen and heard) in the body of the recipient's e-mail.

2. Description of Related Art

Traditionally, electronic mail, or e-mail, enables a sender to transmit a text message from his/her computer via the internet to a server, where the message is stored and delivered to a recipient when the addressee is ready to view it. The basic e-mail system includes a front-end mail client and a back-end mail server.

The e-mail server traditionally is a program running on a network server that the e-mail client contacts to send and receive e-mail messages. Usually a sender uses an e-mail client such as Outlook® or an Internet-based e-mail system such as Hotmail®, Yahoo®, or AOL® to send and/or receive e-mails. Internet-based e-mail systems use a SMTP (Simple Mail Transport Protocol) mail server to send mail and a POP (Post Office Protocol) server to receive mail. After an e-mail is sent, the e-mail client contacts the corresponding SMTP mail server. The SMTP mail server transmits the message to a POP server, where it is sorted and made available to the recipient.

When the recipient is ready to view incoming messages, the recipient's e-mail client connects to the recipient's POP server and requests the messages that have accumulated in the mailbox. Traditionally, e-mail is used to transmit basic text from one person to another. More recently, e-mail usage has developed to also include transmission of RTF (Rich Text Format), which can add various fonts, text sizes and colors to e-mail text.

Conventional e-mail systems embody many disadvantages. For example, under current e-mail systems, the sender can only e-mail text with some variations in font type, size, and color, and send images and media files as attachments. If a media file is on a website, they can include a link to the website for the recipient to click after reading the e-mail.

Another problem with current e-mail systems is that they do not provide the ability for most individuals to send media, images, links and text at one time within an e-mail using his/her standard e-mail client (Hotmail®, Yahoo®, AOL®, and Outlook®) or via a form on a website. In addition, they have no means to modify the content within these e-mails after they are sent to one or more recipients.

Yet another limitation of current e-mail systems is that the sender cannot have media, images, links and text in his/her signature file at the same time, especially without the media file and images being included as attachments. In addition, if the sender wants to change the information, image(s) or media included in his/her signature file, they have to manually do so and the previously sent e-mails will show the outdated information.

Further, another problem with current e-mail systems are that users of most web-based e-mail systems can not determine if an e-mail has been opened by the recipient or if it has been opened multiple times on various computer systems that may or may not belong to the original recipient.

Yet another issue with current e-mail systems is that the sender has no means for communication between the e-mail, which has been sent to the recipient, and a database to update the status and then send the latest information to the recipient's e-mail once it has been sent.

Another problem with current e-mail systems is that the sender does not have the ability to automatically change a previously sent e-mail, based on an action by a recipient in the future.

With current e-mail systems, a recipient can download text, images, or media files without the permission of the original sender and resend them to others without the authorization of the sender, which can present problems.

Other limitations of the current e-mail system include that a recipient can only set his/her preferences within most e-mail clients to accept all images/media or deny the viewing of all images/media as a default. Neither can a recipient enter into an e-mail system their preferred browser, type of computer, or internet connection information in order to receive the most appropriate type of content in their e-mail based on their system configuration. Further, sometimes media that is embedded in an e-mail is disturbing and obtrusive when unexpectedly opened in a work environment. Parents may want to limit their children's access to certain hours of the day or prevent them from receiving certain content in general.

Yet another problem with current e-mail systems is that they do not include an option for a sender to allow third party advertisements of images or media files to be included with text, images, or other media files in sent e-mails.

Further, current e-mail systems do not include the ability to process or manage e-mails-based on a hierarchy preference system, which takes into account the recipient, administrator, sender, and marketer interests as it relates to an e-mail or group of e-mails.

Another problem with current e-mail systems is that they do not include the ability for a sender to log and access date and time information for every instance of an e-mail being opened. Neither do they provide the ability to log the one or more IP addresses associated with a recipient and his/her unique e-mail address.

The current e-mail systems are further disadvantageous in that they do not take into consideration that a recipient may send the e-mail to a specific individual or groups of individuals, which the sender may not want to receive a copy of the e-mail.

Yet another problem with current e-mail systems is that they allow an e-mail recipient to share with other co-workers or individuals the content of an e-mail message by providing them a virtually unlimited amount of time to invite others to his/her computer screen to read the e-mailed message.

Problems with current e-mail systems further include that while they provide the ability for a recipient to easily save the e-mailed image to his/her computer for future access, they do not provide the ability for an e-mail marketer or sender of an e-mail to track the forwards of the original e-mail and the media files, which are embedded within the e-mail.

The present invention embodies solutions over the above-described limitations inherent in the conventional e-mails systems. The present invention enables a sender to send text, links, images, audio and/or video (media) via e-mail directly from a website or using his/her desired e-mail client (i.e. Outlook®, Hotmail®, Yahoo®, AOL®, etc) and it being immediately available (seen and heard) in the body of the recipient's e-mail.

The present invention does not require the use of e-mail attachments or the recipient clicking on a link to go to a website to access the desired content. The media is automatically played and images are made visible within the recipient's e-mail when the recipient opens his/her e-mail utilizing his/her preferred e-mail client. The e-mail client then accesses the necessary files via embedded links, which are within the e-mail.

The embedded links may also be used to create a dynamic signature file that can be inserted once into the e-mail client's signature areas and later modified by logging into a website and choosing an alternative media file, text, links and images for inclusion within the signature.

The present invention further provides the flexibility for the sender to easily modify the content of previously sent e-mails by logging into a website, selecting an e-mail or desired groups of e-mails, and choosing an alternative media selection from a pre-recorded library of clips or editing the text associated with the e-mail. This can also be done automatically by the sender creating a set of pre-defined rules that are a function of time, open history, internet connection properties, and/or IP addresses of the computers on which the e-mail(s) is opened, thereby creating a system to track the e-mail.

The present invention also includes an option for a hierarchy system that takes into account the preferences of the recipient, administrator, sender, and any marketer who may also be involved to some degree with the e-mail. This hierarchy system ensures that the desires of the recipient and requirements of the administrator as it relates to the sending and receiving of text, media, links, and images in e-mails supersedes the desires of senders and marketers who may send text, media, links or, graphics that may not be desired by the recipient for one reason or another.

In order to ensure that a sender does not circumvent the system in an attempt to e-mail a media file without the corresponding images and embedded links associated with the media file, a checks-and-balances system verifies that both the media and all applicable images are included within each e-mail before any media is played. E-mails can also be sent that have been divided into X*Y smaller images, making it more difficult for the recipient to save the content. For example, a single image can be divided vertically into 4 images and horizontally into 3 images, for a total of 12 separate images.

In addition, an e-mail may have an expiration time (from seconds to weeks) when the e-mail will expire or be automatically modified-based on a set of pre-defined rules. This option can include a countdown timer that warns the user of the limited time left until expiration of the currently viewed e-mail. This includes the ability for the e-mail to expire or disappear from view while the recipient is still reading the e-mail. Therefore, it can be seen that a need yet exists for an enhanced e-mail system, and it is to such a system that the present invention is primarily directed.

### BRIEF SUMMARY OF THE INVENTION

Briefly described, in its preferred form, the present invention, the XT system, is an improved e-mail system incorporating capabilities not before provided in e-mail. The present invention is a system to send, track and dynamically modify images, links, text, audio, and video in an e-mail.

The present invention according to one preferred embodiment includes a process for sending media (video and/or audio) from a website (or e-mail client) to a recipient that is played in the body of the e-mail message and can be dynamically altered by the sender by logging into a website and modifying the previously sent e-mail or by implementing a set of pre-defined rules that are associated with the e-mail.

In another preferred embodiment, the invention is a process for selecting, previewing, and copying a media file with its corresponding image(s), links, and text for inclusion in a senders e-mail system (i.e. Hotmail®, Yahoo®, AOL®, or Outlook®). The sender can then paste the media and the corresponding elements as desired in his/her newly composed e-mail before it is sent. When the e-mail is received by the recipient, the media will play and the graphics will be visible in the body of the e-mail.

In yet another preferred embodiment, the present invention is a process of previewing, selecting, and sending a media file with its corresponding images, links, and text from a website via a website form and sending to a recipient's e-mail box where the media is played within the body of the recipient's e-mail without there being an attachment or the recipient clicking an external link.

The present invention can include a process for changing a media file that is played in an e-mail after it has been sent by logging into a website, selecting the sent e-mail from a log, and choosing a different media file to be seen by the recipient when it is next opened in his/her e-mail.

The present invention also includes a process for modifying the content of an e-mail (including media, text, links and images) based on pre-defined rules or preferences that are a function of time, date, number of opens, internet connection properties, IP address(es) of computers opening e-mail, or other action(s) by a recipient or group of recipients.

The present invention further includes a process of using an embedded link that accesses and updates information in a database, which dynamically creates an image and sends media and/or text-based on the information stored in the database that is seen and/or heard in the recipient's e-mail

In yet another preferred embodiment, the present invention includes a method to hinder the modification of e-mail content if a recipient attempts to change the content and send to another party without the original sender's permission.

The present invention can further include a process of verifying the presence of the appropriate image(s) and embedded links that correspond to a specific media file prior to the media file playing in an e-mail. By checking the consistency of a unique key embedded in all links within a set period of time from the requesting e-mail client to the host server, verification or denial of download rights to the requesting computer takes place prior to permission being granted for access to the requested media file. This process can also be applied to the accessing of link and text requests as well.

Another preferred embodiment of the present invention includes a process for creating, previewing and copying a signature for placement as a signature file within a sender's preferred e-mail client which utilizes HTML (HyperText Markup Language) or RTF. The newly created signature file provides the ability for media, links, images, and text within the signature file to be modified by logging into a website account and making the desired changes, without the necessity of re-pasting or even accessing the signature code, which is in the e-mail client itself.

Another process of the present invention includes one of providing an e-mail recipient the ability to log into a website to modify his/her XT e-mail receiving preferences which provides them the ability to designate the time span, type of media, types of images, embedded text, or e-mail sender(s) from which they would or would not like content to appear within his/her e-mail. This is applicable to e-mails sent from the XT website or sent utilizing the XT system via the senders preferred e-mail client by cross referencing the recipients IP address(es). This process can also include a sub-process for the recipient to designate that they would only like to have media play in his/her e-mail box between certain hours of the day and remain inactive during other hours of the day.

The present invention can further include a process of an administrator modifying the content (links, text, media, and/or images) of an e-mail(s) that has been sent by a sender to a recipient or group of recipients because of offensive content within the e-mail(s), non-payment for services, the expiration or canceling of the business relationship, the application of a function to dynamically rotate marketing ads within e-mails, or for other reason(s) at the discretion of the administrator.

In yet another preferred embodiment, the present invention includes a process for providing the ability for a sender to modify or remove content which includes media (audio and/or video), text, links, and images from a previously sent e-mail by logging on to a website and changing the images, text, links, or the media selection in the e-mail to the recipient. The sender can also completely remove all components of the file and replace them with simply a blank page or exchange the original e-mail content with an alternative e-mail message.

A preferred process can further include a process of providing e-mail users the ability to manage e-mails that have been sent and apply specific rules related to them such as under what circumstances to modify the text, media, links or images in any of the messages. It also provides the ability to modify/update the body of any of these e-mails with the latest information that has been recorded in a database or has been formulated-based on defined rules that have been previously entered into the system.

Another preferred embodiment of the present invention includes the process by which a marketer can modify an image or a media advertisement which is viewable in an e-mail-based on the effectiveness or lack of effectiveness of his/her e-mail marketing campaign. This can be-based on previously set measurement criteria or modified at the discretion of the marketing team. These changes would be effective when e-mails sent by XT users are opened or re-opened by each e-mail recipient.

A process is also disclosed herein of managing e-mails sent utilizing a hierarchy methodology for the content, media, links, and images, which are available in an e-mail. The hierarchy takes into consideration the complimentary and sometimes conflicting preferences set by various groups (i.e. recipient, administrator, sender, and marketer) for specific or groups of e-mails. This includes preferences that can modify the content of previously sent e-mails as a function of time and open history if it now conflicts with the preferences that were set prior to an e-mail originally being sent or because of a modification to the preferences after the e-mail was sent.

The process of storing time, date, IP addresses, internet connection properties, and open history for specific e-mails for tracking, analysis, as well as manual and automated decision making is another preferred embodiment of the present invention.

The present invention can include a process of granting or limiting access to information within an e-mail as a function of the recipients IP and/or e-mail address.

In another preferred embodiment, a process is disclosed for modifying the format of text and images that were submitted in a webpage and creating an animated GIF (Graphics Interchange Format) of the originally submitted message that expires or disappears from in front of the recipient after a designated period of time (from seconds to minutes). If the e-mail is re-opened, it now shows a blank page, alternative content, or an expired e-mail message.

The present invention further comprises a process of modifying the format of text and images that were submitted in a webpage and creating an animated GIF of the originally submitted message that changes to an alternative message while the e-mail is still open in front of the recipient after a designated period of time (from seconds to minutes). If the e-mail is re-opened, it now shows the replacement message or alternative content.

Another preferred embodiment of the present invention is the process of breaking an e-mail into multiple images that are X*Y dimensions to make it more difficult to save the content of an e-mail. This involves the process of making the text and images associated with the original e-mail one image, and converting that single image into X*Y images that can be reconfigured into the original image in an RTF or HTML email. The subsequent HTML page is e-mailed to the recipient.

The present invention can further include the process of creating an embedded e-mail form for forwarding an exact or modified version of an e-mail, which includes media and images from within the recipients e-mail or from a corresponding link that can be accessed from within the e-mail. It also involves the storage of e-mail addresses, IP addresses, open history, and other applicable information for the original sender, previous sender, current sender, and recipient. These and other objects, features and advantages of the present invention will become more apparent upon reading the following specification in conjunction with the accompanying drawing figures.

### BRIEF DESCRIPTION OF THE SEVERAL VIEWS OF THE DRAWINGS

FIG. 1 is a schematic of a traditional method for sending e-mails.

FIG. 2 is a schematic of a method for sending media in e-mails according a preferred embodiment of the present invention.

FIG. 3 is a schematic of a disappearing e-mail animated GIF according a preferred embodiment of the present invention.

FIG. 4 is a schematic of e-mail content split into X*Y images according a preferred embodiment of the present invention.

FIG. 5 is a schematic of a dynamic e-mail signature according a preferred embodiment of the present invention.

FIG. 6 is a schematic of a one click copy code according a preferred embodiment of the present invention.

FIG. 7 is a schematic of e-mail modification preferences of dynamic e-mails utilizing a hierarchy methodology according a preferred embodiment of the present invention.

FIG. 8 is a schematic of e-mailing tracking and recipient information storage according a preferred embodiment of the present invention.

FIG. 9 is a schematic of the various regions for images, text, media and links of a dynamic e-mail signature according a preferred embodiment of the present invention.

### DETAILED DESCRIPTION OF THE INVENTION

The present invention is a method of sending a message containing content that can be altered or changed dynamically after the message has been sent. Preferably, the method is executed by means of a computer program. The preferred means of sending the message is through email. However, the message can take the form of any type of electronic content, and the medium for accessing the content can be any of an MP3 player, television, radio, telephone, or other internet based means of communication. The sender of the message can select or enter content that is to be sent to a recipient or multiple recipients. An electronic reference is associated to the content. The electronic reference is then transmitted to the recipient in the form of a message. When the recipient receives the message, the electronic reference accesses the content. The sender of the message can change the content that is associated with the electronic reference after the message has been sent. When the recipient receives or accesses the message again, the electronic reference will access the new content selected by the sender.

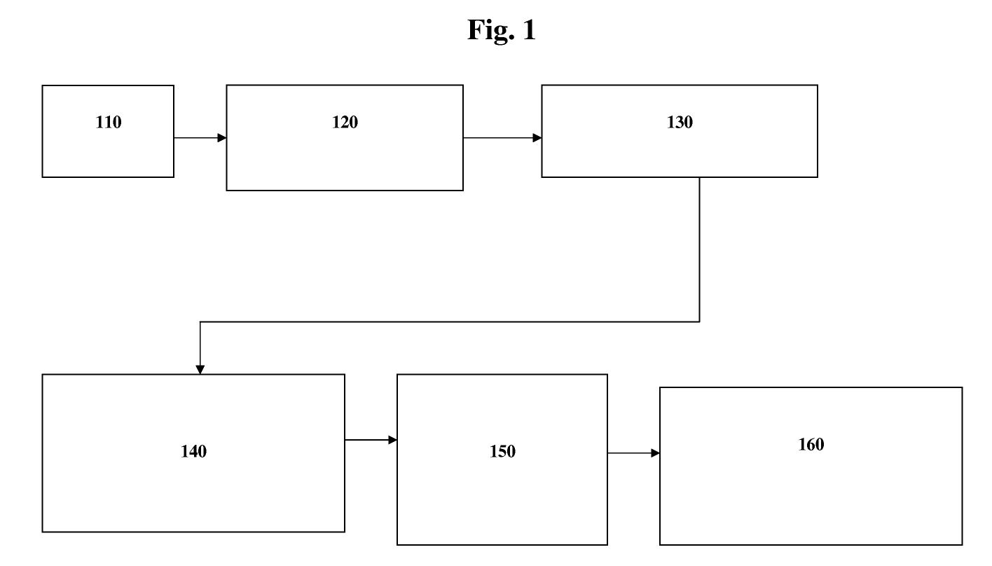

Referring now in detail to the drawing figures, wherein like reference numerals represent like parts throughout the several views, FIG. 1 illustrates a conventional e-mail system. First, at step 110, a sender logs into account to write and send a text e-mail. At step 120, the sender's e-mail client communicates with the sender's SMTP server in order to send the e-mail to the recipients e-mail server. The sender's SMTP server obtains the IP corresponding to the domain name associated with the recipients e-mail server at step 130. At step 140, the sender's SMTP server communicates with the recipient's server and sends the e-mail message to recipient's server which saves the e-mail for the recipient to access at his/her convenience.

The recipient at step 150 then checks his/her e-mail client, which obtains the new e-mail message accessed from the POP 3 connection with the server. Lastly, at step 160, the recipient reads the message and then either saves the message to his/her local computer/e-mail client, leaves message on the server, or erases the message.

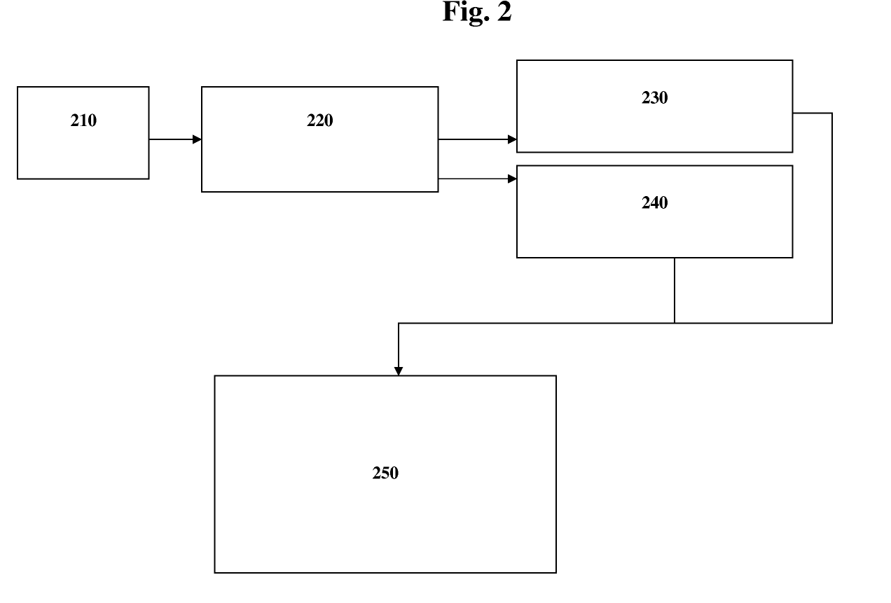

The present invention as shown in FIGS. 2-9 relates to various subsystems of the invention, providing the ability of a sender to e-mail text, image(s), links, audio, and video in the body of his/her e-mail. Each feature is briefly described below, wherein a more detailed description is provided hereinafter.

A preferred method for sending media in e-mails according to the present invention is shown in FIG. 2. A sender logs 210 into account to select media file. The sender then samples at step 220 various clips, and selects the desired one to e-mail. The sender can then either at step 230 enter the recipient, subject, and body text in a web page form to send e-mail, images, links and clip to the desired recipient(s), wherein the message is sent, or at step 240, the sender sends e-mail from his/her preferred e-mail client and paste selected text, images, links and/or media into the e-mail, wherein the message is then sent.

At step 250, the recipient opens the e-mail, and the image(s), link(s), media, and text originally entered and selected are created into a new graphic image based on the requested database information that is called by the embedded link within the e-mail. The recipient sees the e-mail content and the selected media file playing in the body of his/her e-mail with an image and link corresponding to the media file.

A preferred media file is an animated GIF. An animated GIF can be configured as an image that appears to be a short video clip. When a video clip is uploaded, an animated GIF version is made, for example running three to six seconds. When an e-mail with the video is opened, the animated gif plays. After the video has completely uploaded, the animated gif is replaced by the video. In an email that does not allow videos to be played, the animated gif loops. When the animated gif is clicked, it directs the recipient to a web page where they see the video.

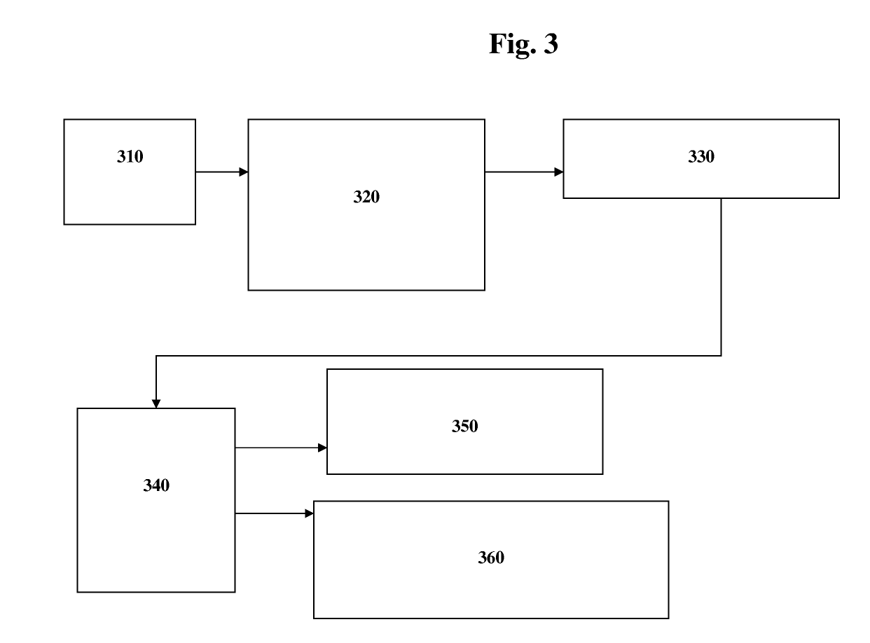

As shown in FIG. 3, a preferred embodiment of a disappearing e-mail animated GIF is shown. First, at 310, the sender logs into account to send a time-sensitive disappearing e-mail. The sender then modifies at 320 preferences for the e-mail tracking and time period (in seconds or minutes) for the page to disappear or be replaced by an alternative message. For example, an animated GIF can be presented with 3 separate sections or frames. The first section would comprise a fraction of a second of blank content and would be displayed first. The second section would comprise the actual GIF image and would display for a predetermined time. The third section would contain continuous blank content and would display at the expiration of the predetermined time of the second section. The sender also decides if a countdown timer is also included in the image. The sender then chooses at 330 the link(s), image(s), and/or media clip, enters recipient(s) e-mail, subject, and body text for e-mail. The information is stored in a database and the e-mail is sent.

The recipient then opens at 340 the e-mail and the latest information based on the preferences and database information is opened in the e-mail. A countdown is either not enabled, 350, or the countdown until expiration is visible in the e-mail, 360. In 350, the image in e-mail expires after previously determine time expires and content is blank on screen or replaced by alternative content. In 360, the image in e-mail expires after countdown gets to 0 and content is blank on screen or replaced by alternative content.

The present embodiment could also employ a counter that tracks the number of times that the email has been opened. For example, the sender could select in the preferences that the content in the email can only be viewed twice. After the recipient opens the email twice, either blank content may be displayed in place of the media file, access to the media file may be denied, or an alternative media may be displayed.

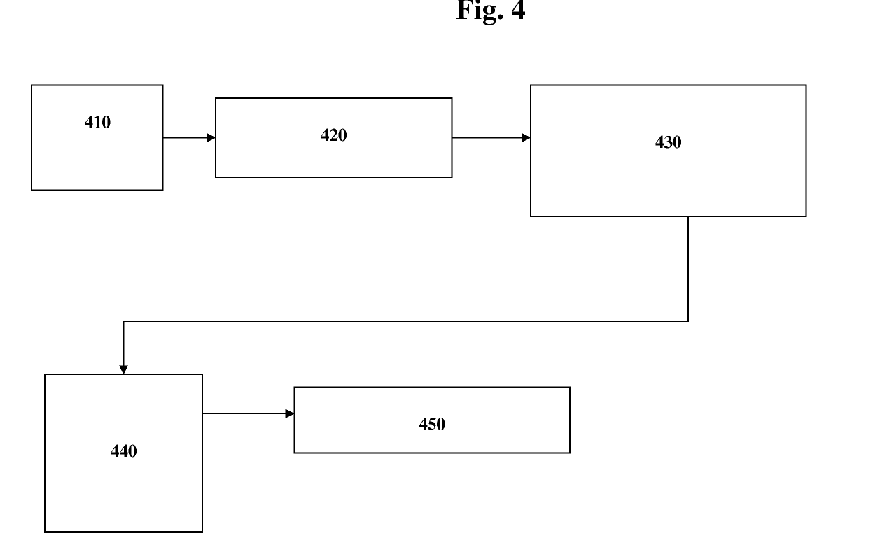

In FIG. 4, e-mail content is split into X*Y images according to a preferred embodiment of the present invention.

First, the sender logs 410 into account to send an e-mail message as X*Y images. The sender then modifies 420 preferences for the e-mail tracking and sets a number of X*Y images for the e-mail to be divided into. For example, a single image can be divided vertically into 4 images and horizontally into 3 images, for a total of 12 separate images.

The sender chooses 430 the media clip, images, and/or link, enters the recipient(s) e-mail addresses, the subject, and the body text for the e-mail. The information is stored in a database and an HTML e-mail is created with image tags to the X*Y graphics that were created based on the original e-mail. The recipient attempts at 440 to right click to save the e-mail. The sender can only save one of the X*Y images at a time. The end result 450, is extremely difficult for recipient to save received e-mail to his/her computer.

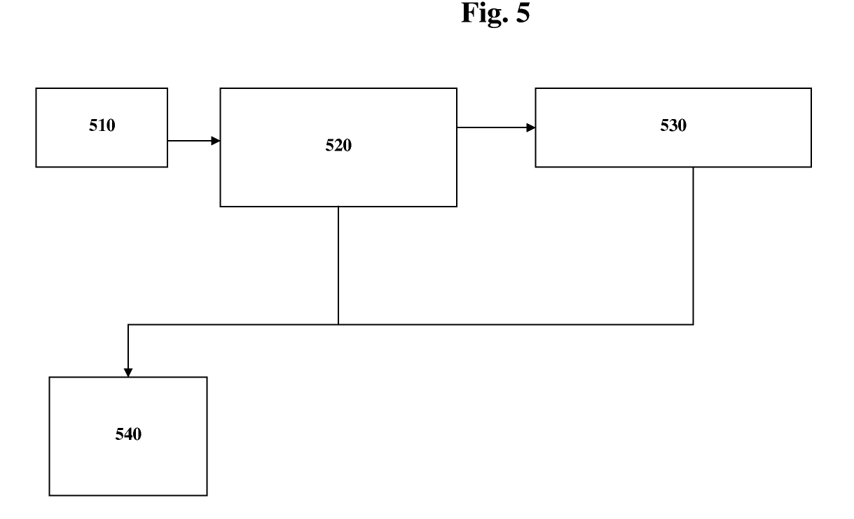

One embodiment of a dynamic e-mail signature is shown in FIG. 5. The sender logs 510 into account to send an e-mail. The sender previews 520 media, chooses media clip, updates website links, and modifies image to include in e-mail signature. The sender saves the settings. Then, at 530, the sender pastes the signature code into his/her desired e-mail client. And from either step 520 or 530 directly, the signature file is updated 540 in past and for future e-mails with updated media, links, text and images.

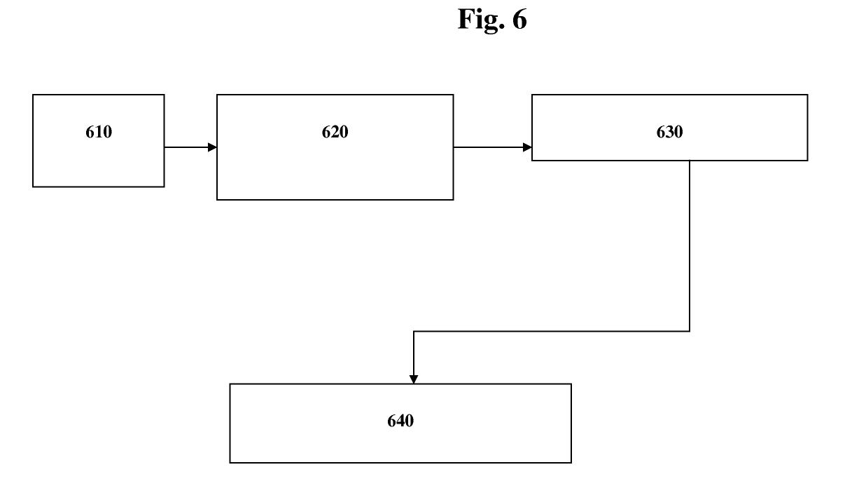

A one click copy code according to a preferred embodiment of the present invention is shown in FIG. 6. The sender logs 610 into account. The sender then samples 620 various clips and selects the desired one to e-mail. The sender can also include text, images, or links. At step 630, the sender opens the “compose new message” area within his/her preferred e-mail client. Lastly, at 640, the sender pastes the selected media, text and graphics into the body area of the e-mail and sends the e-mail as normal.

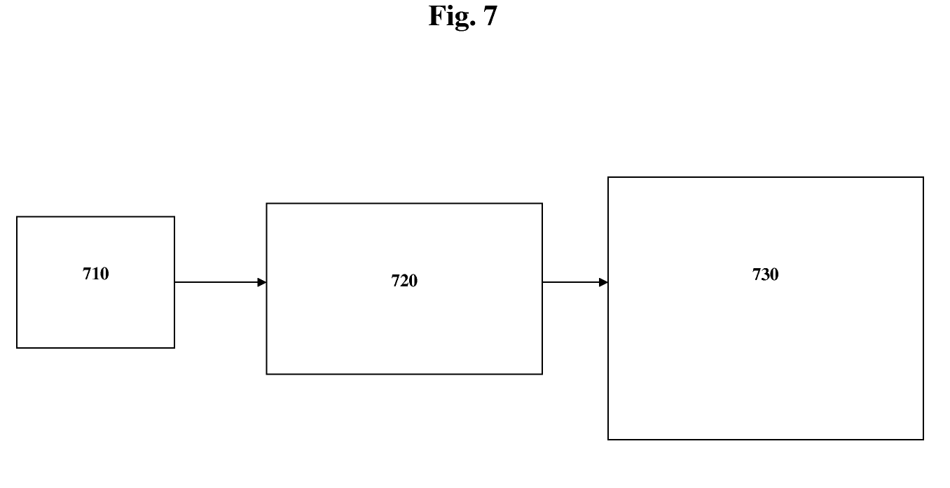

Modification preferences of dynamic e-mails utilizing a hierarchy methodology are shown in FIG. 7.

The following items are assumed:

1. Recipient: logs into website and sets desired preferences for receiving e-mails as a function of time of day, sender, and type of media content (audio, video, genre, or content).

2. Administrator: determines overall system wide rules for sending and receiving XT e-mails and implements any necessary modifications in order to manage content (media, images, links and text) and maintain the integrity of the system and of e-mail transmissions. The administrator can also create functions to determine under what circumstances specific images, links, and media are viewable within a recipient's e-mail.

3. Sender: defines default preferences to apply to all e-mails with the ability to assign custom preferences to specific e-mails. These rules will determine under what circumstances the content within an e-mail will be automatically updated or removed.

4. Marketer: uses prior experiences and acquired information to determine which media and/or graphic(s) should be included in previously sent as well as future e-mails in order to best benefit his/her company with minimum conflict with the higher priority settings of most recipient, administrator, or sender preferences.

The process flow of FIG. 7 includes step 710, wherein the sender enters e-mail system, sets e-mail preferences, selects media, enters text, and sends e-mail (from website or e-mail client). At step 720, the recipient opens e-mail, the e-mail client recognizes embedded link and contacts the XT Website, and the XT Website checks the recipient, administrator, sender, and marketer preferences to determine if full, partial or no access should be allowed to content.

Assuming access is granted for the viewing of content, at step 730, the recipient is now able to see and hear content in his/her e-mail. Database information on the recipient is updated and logged for viewing and analysis by the sender and marketer. The sender and/or marketer can modify content for future recipients based on the previously defined rules, recipient's actions, or at his/her discretion.

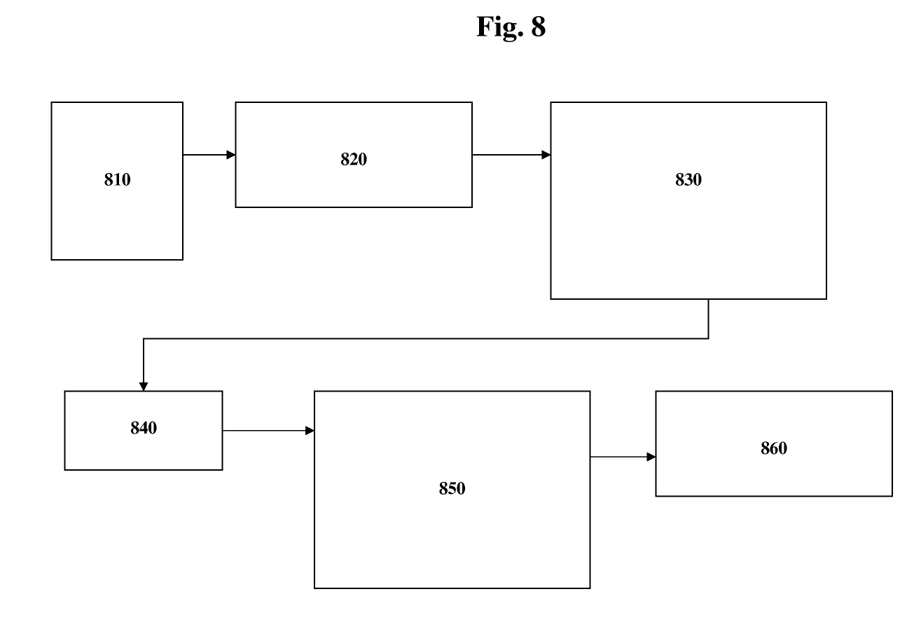

In FIG. 8, an e-mail tracking and recipient information storage subsystem is shown. The sender logs 810 into account and sends e-mail from the website to recipient(s) or from his/her e-mail client to only one recipient. At step 820, a database entry is created containing each recipient's e-mail address, a unique key, and the time with which the e-mail was sent.

At step 830, the first recipient opens the e-mail. The time that the e-mail was opened and the IP address (Internet Protocol address) for the computer utilized is added to the database corresponding to that recipients e-mail address and unique key. A sub-entry is also created with this information for every instance that the entry is opened with a special designation for multiple IP addresses associated with the same e-mail.

The initial recipient forwards 840 the e-mail to another individual. At step 850, a sub-entry is created for the new recipient who has received the forward. A database entry is created that contains the e-mail address of the original recipient, an appended version of the unique key, and the IP address of the new recipient. This process is repeated for every IP address that is not associated with an original recipient.

Lastly, at step 860, all recipient information is stored and logged for the sender and/or marketer to view and analyze.

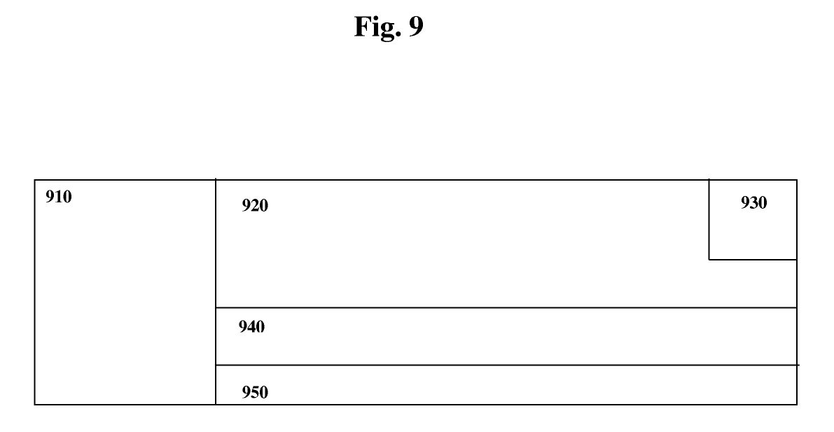

One embodiment of a dynamic e-mail signature with various regions for images, text, media and links according a preferred embodiment of the present invention. The recipient opens their e-mail and sees a signature file as shown in FIG. 9. The recipient sees in 910 either an image or video media playing. This is determined by the sender, administrator and/or marketer. If no video is present, audio is heard. In section 920, the recipient sees a combination of the following information: sender information, title and author of media, and small text message. In section 930 is either an image of the sender or an image related to the media file, such as a picture of the artist or their CD cover. The sender determines what is viewed in this region. In section 940, the administrator will determine if this space is used to provide company information or utilized by a marketer. In section 950, the recipient will see an advertisement from a marketer or sponsor.

Thus, as is evident, the present invention provides the ability of a sender to e-mail text, link(s), image(s), audio, and video in the body of his/her e-mail. By going to a website the sender can choose between numerous media options for sending an e-mail. They can search by name, title, genre, or other category for a list of media options. Using one click, the user can select a possible song to preview, as it would appear in the recipient's e-mail.

The sender can then place that audio or video within his/her e-mail or make another selection. To place the media within his/her preferred e-mail client, the recipient simply places his/her mouse in the RTF body portion of his/her e-mail client and selects Edit→Paste, Cntrl V or right clicks with his/her mouse and selects Paste. The XT (eXTreme E-mail) skin can be inserted anywhere within a message, but is primarily used as a footer or header within the e-mail. The message can also be e-mailed directly from the website with a text message from the sender.

The XT skin is a dynamically created image that combines various graphics, text, links, descriptions, and/or media. The image is generated every time the embedded link accesses the server to retrieve the latest information, corresponding graphic(s), and media files. Since the XT skin is dynamically generated, graphics, media, links and text can be modified with respect to time, tracking of the e-mail, number of times accessed, IP address, internet connection properties, pre-determined functions, probabilistic analysis, target audience, or other sender, administrator, recipient, or marketer preferences.

For marketing purposes, a segment of the XT skin can be dynamically changed to promote various products or services via e-mail. Thus, the present invention allows marketers to utilize consumer-to-consumer relationships as they share media provided by others to the site. In addition, an advertisement, incorporating images, media, links and/or additional text, can be included in the skin. This can be modified at any time, even within the same e-mail, creating an ever changing and evolving experience for the e-mail recipient. For example, the advertisement can be automatically changed based upon the type of media file selected by the sender or information related to the age, sex, gender, geographic region, or other demographic information of the sender and/or recipient.

One of the many significant aspects of the present invention is that the audio or video are played within the recipient's e-mail body without the necessity of clicking on an outside link and viewing in a webpage, downloading of the file to his/her computer, or having a large attachment connected with his/her e-mail. All media, images, links, and text associated with the images are housed on a server separate from either e-mail client. This provides the benefit to the recipient of saving space in his/her e-mail box, and gives the sender the ability to modify the content of the e-mail. This provides a dynamic e-mail experience for the recipient, and thorough tracking of the e-mail message for the sender.

There can be various links included in the skin corresponding to various zones or regions. When clicked, these zones can open a browser window that provides the recipient additional information on the clip which they just heard, the person sending the e-mail, an advertisement within the e-mail or information about the XT e-mail service and how they can send in his/her own e-mail.

Although one focus of the invention is on media and images within an e-mail, the dynamic nature of the technology is also applicable to links and text-only e-mails. An entire e-mail message, not just the XT Skin, can be dynamic. All information that is to be included in an e-mail can be created by the sender logging into his/her account via the XT or other corresponding website. Although the e-mail message can be placed within his/her desired e-mail client using one click as described above, by sending the e-mail directly from the website, specific e-mails can be tracked as they are opened by multiple recipients. When the e-mail is opened, the following information is associated with each recipient:

1. The time the e-mail was initially opened;

2. Number of times the e-mail was accessed;

3. The IP address associated with each computer opening the e-mail and the corresponding time for which the e-mail was opened on each computer;

4. The individual who sent them the e-mail;

5. Internet connection properties such as the approximate speed of their connection.

The e-mail can also be designed where there is a form embedded in the e-mail such that the recipient can immediately forward the e-mail to another individual after selecting specific options, or click on a link that takes them to a website where they can send the same e-mail or a modified version of the e-mail (containing text, links, images or media) to another recipient. The information, as cited above, could also be stored for each new recipient, and so on.

Another aspect of the invention is the ability to dynamically change the e-mail based on a hierarchy system. The hierarchy for making decisions concerning the e-mail could be as follows:

First Priority: Recipient

Second Priority: Administrator

Third Priority: Sender

Fourth Priority: Any advertiser or marketer associated with the e-mail

### Recipient Options:

A recipient who has registered his/her e-mail address and IP address with the present system can set certain preferences for the receipt of e-mails to his/her e-mail box and/or computer. This provides a means for not just e-mail recipients, but also parents to monitor the XT e-mails received in his/her e-mail box or that of minors. Some recipient preferences could include the following:
1. Block e-mails totally containing videos
2. Block media from playing but keep the images, links, and text
3. No e-mails containing advertisements
4. No e-mails with audio or video between specific hours (i.e. none between the hours of 9 am and 5 pm)
5. No e-mails containing media from a certain individual, group, or genre
6. Only send media that is less than 1 megabyte.

### Administrative Options:

The second in priority is the administrator. The administrator can set certain constraints on the accounts of the marketers, sender and recipients based on the content, size and type of media, time of day, number of opens, individual accessing the content, or usability constraints placed on the marketer, sender or receiver accounts.

### Sender Options:

The sender can place numerous rules on his/her e-mails; however, none of these rules can conflict with any constraint set by the recipient or administrator. For example, the sender cannot force any recipient who has set up preferences for his/her e-mail account not to access media contained in an e-mail between 9 am and 5 pm to do so. Neither can the sender expect for a recipient to be able to even view previously sent e-mails from the sender, if the sender's account has been terminated or temporarily disconnected by the administrator. Considering that under most circumstances, the sender has a relationship with the recipient and is in good standings with the administrator, this should rarely be a problem.

With the present invention, the sender now has some influence over the e-mails that they have sent out in the past. If they have written something in error, they can modify the text and it will update in the recipient's e-mail box. If the sender would like for e-mail recipients to access a different media file, link, or image the next time that the e-mail is opened, that differs from what was sent originally, they can do this also. Other possible preferences that can be modified by the sender are outlined below:

1. Removal or modification of the content and media associated with the e-mail after a set period of time.

2. Removal or modification of the e-mail after a certain number of opens

3. Removal or modification of the e-mail if an unrecognized or additional computer accesses the e-mail.

4. Removal or modification of the e-mail-based on the number of different computers which have accessed the file

5. Modifications to an e-mail-based on pre-determined rules or as additional information is gathered on the open history or other information associated with a sent e-mail.

Additional dynamic e-mail functionality can also limit the recipient's ability to copy, save or share the file. For example, the e-mail content can be created using an animated GIF that expires after a count of, for example, 30 seconds. As a result, the image would disappear from the user's screen after approximately 30 seconds (this will vary-based on download time and the recipient's computer configuration). This would give the recipient a limited opportunity to grasp all of the key points included in the e-mail, while making it difficult for them to document or share the information with another party. If they then closed and re-opened the same e-mail, it could show entirely different content, an expired message or a blank page.

The sender can also include with the e-mail a counter that counts down in certain increments. This would give the recipient forewarning of the life span of his/her e-mail whether it be seconds, minutes, days, etc. This counter could be set to increment-based on other criteria as well, such as time, number of opens, or number of different computers that have accessed the e-mail.

If the sender has the IP associated with a specific individual's computer and e-mail address, they can designate that these specific IP addresses cannot view the content of an e-mail which they have sent to a recipient or create a rule that the message will automatically be modified if accessed by the previously entered IP address(es). Conversely, the sender can also set that only designated IP addresses can access the e-mail or the e-mail is modified-based on previously determined criteria.

The sender is able to view the original message, default rules and additional rules associated with each e-mail when they view the e-mail history in his/her online XT e-mail login account.

### Marketing/Advertiser Options

A marketer or advertiser has numerous options in creating and customizing his/her marketing campaigns over time-based on the response rates of e-mail recipients. The present XT system can track the number of views as well as the click through rate for each type of graphic that is included within an e-mail. By comparing the views, click-through rates, and final actions of the recipient with the marketers desired results, marketers can make knowledgeable decisions related to the effectiveness of one ad versus another.

If it is found that one ad is clearly more effective than another, the marketer can choose to modify the image that was included in the previously sent e-mails that was not effective and replace with the more effective ad. In addition, through the dynamic nature of the campaign, the system can be set to play a media ad every third time, for example, a recipient opens his/her e-mail. The included graphic, link(s) and media associated with the advertisement can be modified at the marketer's discretion as well.

With this tool, the advertiser is able to “piggy back” on the numerous relationships of the sender of an e-mail in his/her normal daily e-mail correspondence.

Just like with the sender, the marketer's preferences do not supersede that of the administrator or recipient. The marketer's ads that have been previously e-mailed can be changed by the administrator based on marketing agreements with advertisers which describe the frequency at which ads and links are rotated, lack of payment, the advertiser is no longer a client, or at the discretion of the administrator.

### Signature File

An e-mail signature file is often used to share the sender's name, address, phone number, e-mail, company, or other information with a recipient without the necessity on the sender's side to re-write this information in every e-mail that is sent. The present XT system provides the ability for the sender to embed text as well as images, and media content in his/her signature file.

After the sender places his/her unique “Signature Code” in his/her designated e-mail system, they can quickly and easily change the text, media, and images associated with the signature file by modifying his/her preferences on the XT website. After his/her preferences have been modified, his/her current signature information as well as that contained in previously sent e-mails is automatically updated. The media content can be a musical artist, speaker, friend, or a self-recording. Any aspect of the signature file can be modified at the discretion of the sender and updated in the recipient's e-mail box the next time they are accessed and the corresponding information is obtained from the XT website.

The invention further relates to the ability of a sender to send text, links, images, as well as audio and/or video (media) via e-mail directly from a website or using his/her desired e-mail client (i.e. Outlook®, Hotmail®, Yahoo®, or AOL®). The sender has the flexibility to easily choose from a library of pre-recorded media or upload his/her own media to the library. After selecting a media file, a corresponding link and/or image as determined by the administrator, is associated with the file. The sender can either write his/her e-mail text at the website after selecting a media clip or paste the graphic and embedded link to the media file in his/her preferred e-mail client and send the e-mail to the desired recipients. Based on the settings of the recipient's e-mail client, network, and local computer, the recipient will hear and/or see the media, image(s), and corresponding text within the body of his/her e-mail.

This embedded signature may also be used as a dynamic signature file that can be inserted once and modified by logging into a website and choosing an alternative media file, image, link, and/or text for inclusion in the newly created signature.

The system also provides the ability for the sender to modify the text, links, images or media file included in previously sent e-mails. This modification can be a function of time, date, send and open history, number of views, IP address as well as previously determined functions and probabilistic formula. The e-mail can be sent with the ability to “expire” even before the recipient has the ability to close the e-mail. By capturing the above information for the e-mail, detailed tracking of the initial recipient's e-mail as well as information as it relates to additional recipients who may have received the e-mail through a reply or forward is also stored in a database.

Thus, as fully described hereinabove, the present invention provides a novel and non-obvious e-mail system that overcomes the many disadvantages of the conventional e-mail systems. As shown, the present invention allows the sender to select from pre-recorded audio or video (media) files or upload an original media file to a server. The sender can then send an e-mail that has an embedded link to the source file such that the recipient can see an image, view and/or hear the media file, or click a corresponding link, when the e-mail is opened and the e-mail client contacts the web page referenced in the embedded link. It resolves another problem by not being an attachment which would take up space in the recipients e-mail box and require the added step of choosing to save the media to his/her computer. Because of the embedded link that is automatically activated by the e-mail client, the recipient does not have to click a link nor access images or media by going to a website.

The current invention also gives the sender the ability to log into a website, preview a media file, and send an e-mail directly from a webpage with images, links, text and embedded media file included. Or the sender can return to his/her “compose new message” within his/her e-mail client and paste the media file and the corresponding text, links and/or image(s) directly into this e-mail message. The sender also has the ability to modify a previously sent e-mail by logging into the website, selecting from a list of previously sent e-mails and choosing a different media clip, link(s), image(s), or typing alternative text for inclusion in that e-mail.

The current invention also provides the sender the ability to include media, links, images, and text all in his/her signature file and pasting it in one step after previewing and selecting his/her desired signature file on the website. The sender can quickly change his/her signature file by logging back into the website and creating an alternative signature file. The signature that was included in the previously sent e-mails will be updated and the sender is also ready to send e-mails out with the new signature file from his/her preferred e-mail client.

The current invention further provides the sender the ability to track whether an e-mail has been opened by the designated recipient and keeps track of the time, date and IP address associated with the computers on which it was opened. In addition, this information is logged every time the e-mail is opened so that the sender can determine if the e-mail was opened on more than one computer and possibly forwarded to another individual without his/her knowledge. The invention also provides assurance to the sender that the content of the message has not been modified by anyone else and then sent again.

The present invention includes an embedded link that communicates with a database that can store information concerning the e-mail and provide updated information to the e-mail recipient.

The present invention provides the sender the ability to create a set of rules, which govern the content (text, links, media, and images) which are included in the e-mail. A sender can create a rule that if this e-mail is accessed by more than two different IP addresses, for the system to change the e-mail content from “Content A” to “Content B” and if it accessed more than five times within twelve hours, change the e-mail content to “Blank Page”. This provides the sender the flexibility to define under what circumstances they want specific content to be accessed or be un-available.

The current invention can further verify the presence of the appropriate image(s) and embedded links which correspond to the requested media file in a recipient's e-mail prior to granting the recipient the ability to access (view or hear) the requested media file.

The present invention further first compares the content of the e-mail with the recipient's current settings in his/her account. This provides the recipient with the ability to designate the time range, type of media, types of images, links or embedded text, or e-mail sender(s) from which they would or would not like content to appear within his/her e-mail.

The current invention gives the recipient the ability to set the preference, for example, that no media should be played in his/her e-mail between 9:00 am and 5:00 pm and no media from these specific e-mail addresses or as it relates to these musical genres should ever be visible within their e-mail box.

Further, the present invention provides marketers, with the approval of the recipient, administrator, and sender, the ability to include images, links and/or media advertisements related to his/her company along side music, spoken word, pictures, and text within an e-mail. In addition, the marketer can modify these advertisements-based on the effectiveness or lack of effectiveness of the e-mail-based campaign. These modifications can be automatically made-based on pre-defined measurement criteria or modified at the discretion of the marketing staff by logging into a website and making the desired changes. These updates would be effective when new e-mails are sent by XT users or when previously sent e-mails are re-opened by each e-mail recipient.

The current invention further utilizes a hierarchy methodology for viewing preferences related to the content, links, media, and images, which will be available in an e-mail. The hierarchy takes into consideration the complimentary and sometimes conflicting preferences set by various groups (i.e. recipient, administrator, sender, and marketer) for specific or groups of e-mails. These preferences can be applied to previously sent e-mails as well as used to modify the content that is viewed in future e-mails.

The current invention utilizes a process of storing time, date, IP addresses, and open history for specific e-mails for tracking, analysis, and manual or automated e-mail content modifications.

The present invention further provides the ability for the sender to limit the e-mail content to only being accessed by specific individuals-based on the stored information corresponding to the desired recipients e-mail and IP address(es) stored in the senders user log. Alternatively, the sender can set specific IP addresses, which they do not want to access the e-mail content and make the content appear blank or change the content to an alternative message.

The current invention can modify the format of text and images originally submitted in a webpage to be sent via e-mail. The XT system creates an animated GIF of the originally submitted message that expires or disappears from the recipient's e-mail client (even while the recipient is viewing it) after a designated period of time (from seconds to minutes). If the e-mail is re-opened by the recipient, the e-mail now displays a blank page, an alternative message or an expired e-mail message.

The current invention further can first make the e-mail message into an image, and then break the newly created image-based on the original e-mail into multiple images that is X*Y separate images. By e-mailing script that calls the X*Y group of images using image tags that form one complete e-mail message to a recipient, the ease with which an e-mail can be copied is drastically reduced.

The invention further provides the ability for a sender to include a “Tell a Friend” form in his/her e-mail. With the cooperation of numerous e-mail recipients, a copy of the original e-mail or a modified version of the e-mail can be forwarded, which can include text as well as media and images. The original e-mail can be forwarded utilizing a form that is within each recipients e-mail or accessed by the recipient clicking on a link that accesses an external web page. This option also involves the storage of e-mail addresses, IP addresses, open history, and other applicable information for the original sender, previous sender, current sender, and new recipient.

While the invention has been disclosed in its preferred forms, it will be apparent to those skilled in the art that many modifications, additions, and deletions can be made therein without departing from the spirit and scope of the invention and its equivalents as set forth in the following claims.

What is claimed is:

1. A method of sending a dynamic electronic message:
selecting or entering content;
associating a reference with the content; and
sending a message containing the reference.

2. A method of sending an e-mail with media content comprising the steps of:
providing to a user a list of media files stored on a server;
storing text entered by the user in a text file on a server;
automatically embedding in an email an embedded hyperlink to a media file selected by said user and/or an embedded hyperlink to the text file so that when either embedded hyperlink is accessed the associated file is accessed;
receiving from said user a recipient email address;
transmitting said email to the post office protocol server of the recipient email address.

3. A computer program product fixed on a computer readable medium that when executed performs the steps comprising:
providing to a user a list of media files stored on a server;
generating an embedded hyperlink to the media file selected by said user so that when the embedded hyperlink is accessed the associated file is accessed;
displaying an embedded hyperlink so that the user can copy and paste the embedded hyperlink.

4. The computer program product of claim 3, further comprising the steps of:
storing text entered by the user in a text file on a server; and
generating an embedded hyperlink to the text file so that when the embedded hyperlink is accessed the associated text file is accessed.

5. The computer program product of claim 4 further comprising the step of:
changing the media file or text file associated with an embedded hyperlink when the user enters different text or selects a different media file to be accessed when the embedded hyperlink is accessed.

6. A computer program product fixed on a computer readable medium that when executed performs the steps comprising of:
providing to a user a list of media files stored on a server;
storing text entered by the user in a text file on a server;
automatically embedding in an email an embedded hyperlink to a media file selected by said user and/or an embedded hyperlink to the text file so that when either embedded hyperlink is accessed the associated file is accessed;
receiving from said user a recipient email address;
transmitting said email to the post office protocol server of the recipient email address.

7. The computer program product of claim 6, further comprising the step of:
changing the file associated with an embedded hyperlink after an amount of time predetermined by the user has elapsed from the time an embedded hyperlink is accessed

8. The computer program product of claim 7, further comprising the step of:
embedding in the email an embedded hyperlink to a file that displays the amount of time predetermined by the user that is remaining before the file associated with an embedded hyperlink is changed.

9. The computer program product of claim 6, further comprising the step of:
transmitting a media file that after a predetermined period of time contains blank content.

10. The computer program product of claim 6, further comprising the step of:
denying the recipient access to the media file or changing the media file associated with an embedded hyperlink after the embedded hyperlink has been accessed a predetermined number of times.

11. The computer program product of claim 6, further comprising the step of:
changing the media file and/or text file associated with an embedded hyperlink after said email has been transmitted, when the user selects a different media file on a sever to be associated with an embedded hyperlink or enters different text to be provided in the transmitted email.

12. The computer program product of claim 6 further comprising the step of:
recording at least one of the date, time, and IP address associated with an embedded hyperlink being accessed.

13. The computer program product of claim 6, further comprising the steps of:
converting the selected media file into vertical and horizontal components;
storing on a server the vertical and horizontal components; and
associating the vertical and horizontal components with an embedded hyperlink associated to the media file so that when the embedded hyperlink is accessed the vertical and horizontal components are transmitted.

14. The computer program product of claim 6, wherein the embedded hyperlink is embedded in the signature portion of the email.

15. The computer program product of claim 6, further comprising the step of:
automatically disabling an embedded hyperlink or changing the file associated with an embedded hyperlink according to predetermined user preferences.

16. The computer program product of claim 6, wherein the user is the recipient of the email and the preferences relate at least one of time of day, sender, and type of media file.

17. The computer program product of claim 16, wherein the user is the sender of the email and the preferences relate at least one of the number of times an embedded hyperlink has been accessed, time elapsed from when an embedded hyperlink was accessed, email address, internet connection properties of the recipient, and IP address accessing an embedded hyperlink.

18. The computer program product of claim 6, further comprising the steps of:
generating an animated GIF file related to a selected video media file;
associating the animated GIF file with an embedded hyperlink associated to the video media file; and
transmitting the animated GIF and the video media file when the embedded hyperlink associated when the video media file is accessed.

19. The computer program product of claim 18, wherein the animated GIF is either retransmitted only while the video media file is uploading or continuously retransmitted.

20. The computer program product of claim 19, further comprising the step of:
repeating transmission of the animated GIF if the recipient's email server blocks the transmission of the video media file.

21. The computer program product of claim 6, further comprising the step of:
automatically embedding in the email an embedded hyperlink associated to a signature file.

22. The computer program product of claim 22, further comprising the step of:
splitting the signature file into a first portion and a second portion;
associating the first portion with at least one media file selected by the user and a file containing information related to a media file or the user;
associating the second portion with media selected by a sponsor, advertiser, or promoter.
